(19) United States
(12) Patent Application Publication
(10) Pub. No.: US 2019/0026964 A1
(43) Pub. Date: Jan. 24, 2019

(54) ANALYTICS SYSTEM FOR AIRCRAFT LINE-REPLACEABLE UNIT (LRU) MAINTENANCE OPTIMIZATION

(71) Applicant: General Electric Company, Schenectady, NY (US)

(72) Inventors: Anthony Papa, Liberty Township, OH (US); Michael Urban, Newport, KY (US)

(21) Appl. No.: 15/653,294

(22) Filed: Jul. 18, 2017

(51) Int. Cl. G07C 5/08; G06K 9/62; G07C 5/00; B64F 5/60; G06N 7/00; G06Q 10/06; G06Q 10/08

(52) U.S. Cl. CPC G07C 5/0816; G06K 9/6296; G07C 5/0808; G07C 5/006; G06Q 10/0875; B64F 5/60; G06N 7/005; G06Q 10/06; G07C 5/0841

(57) ABSTRACT

An artificial intelligence based system facilitating improvement of aircraft operation and maintenance. The system can operate on both historical and real-time data to enable proactive cost control. Deep learning can be applied to forecast workscope and generate suggestions for improvement of aircraft operation and maintenance.

### TECHNICAL FIELD

An artificial intelligence based analytics system to optimize aircraft line-replaceable unit (LRU) operation and maintenance.

### BACKGROUND

The subject disclosure relates to reading large quantity of reports. Within the realm of aircraft LRU, the problem pertains to employment of a prohibitive quantity of reports with varying formats and quality that are virtually inaccessible. Conventionally, this information is used by manually reading a voluminous quantity of reports and deducing in a piecemeal fashion how they are interrelated, and then cross-referencing cost data.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, devices, systems, computer-implemented methods, apparatus and/or computer program products that facilitate aircraft line-replaceable unit (LRU) maintenance optimization are described.

In an implementation, an artificial intelligence based system to improve aircraft operational and maintenance efficiency comprises a processor that executes computer executable components stored in a memory. The computer executable components comprise an input component that receives historical and real-time aircraft operation and maintenance data from a set of sources; an archiving component that stores at least a subset of the aircraft operation and maintenance data; and a machine learning component that learns the received and archived aircraft operation and maintenance data, and augments an artificial intelligence (AI) model, wherein the model identifies correlations across a corpus of data, and generates suggestions in connection with improving operation of the aircraft.

In another implementation, an artificial intelligence based system to improve aircraft operational and maintenance efficiency further comprises a data conversion component that converts unstructured archived data to structured data that can be analyzed by the machine learning component.

In another implementation, an artificial intelligence based system to improve aircraft operational and maintenance efficiency further comprises an optical character recognition (OCR) component that converts text document image to unstructured data.

In another implementation, an artificial intelligence based system to improve aircraft operational and maintenance efficiency further comprises a workflow component that schedules aircraft operation and maintenance based on outputs generated by the AI model.

In another implementation, an artificial intelligence based system to improve aircraft operational and maintenance efficiency further comprises an avatar component that generates an avatar that interfaces with a user and provides suggestions to the user based on outputs of the AI model.

In another implementation, an artificial intelligence based system to improve aircraft operational and maintenance efficiency further comprises a virtual reality component that runs simulations using suggestions of the AI model and generates a virtual reality based presentation to a user of one or more of the simulations.

In another implementation, a computer-implemented method for improving aircraft operational and maintenance efficiency comprises employing a processor to execute computer executable components stored in a memory to perform the following acts: using an input component to receive historical and real-time aircraft operation and maintenance data from a set of sources; and using an archiving component to store at least a subset of the aircraft operation and maintenance data; using a machine learning component to learn the received and archived aircraft operation and maintenance data, and augments an artificial intelligence (AI) model, wherein the model identifies correlations across a corpus of data, and generates suggestions in connection with improving operation of the aircraft.

In another implementation, a computer program product for improving aircraft operational and maintenance efficiency comprises a computer readable storage medium having program instructions embodied therewith. The program instructions executable by a processor to cause the processor to: use an input component to receive historical and real-time aircraft operation and maintenance data from a set of sources; use an archiving component to store at least a subset of the aircraft operation and maintenance data; and use a machine learning component to learn the received and archived aircraft operation and maintenance data, and augments an artificial intelligence (AI) model, wherein the model identifies correlations across a corpus of data, and generates suggestions in connection with improving operation of the aircraft.

In some embodiments, elements described in connection with the computer-implemented method(s) can be embodied in different forms such as a system, a computer program product, or another form.

### DESCRIPTION OF THE DRAWINGS

FIG. 1 illustrates an artificial intelligence based system in accordance with one or more embodiments described herein.

FIG. 2 illustrates an example, non-limiting method in accordance with one or more embodiments described herein.

FIG. 3 illustrates an artificial intelligence based system including a data conversion component in accordance with one or more embodiments described herein.

FIG. 4 illustrates an artificial intelligence based system including an optical character recognition component in accordance with one or more embodiments described herein.

FIG. 5 illustrates an example, non-limiting method in accordance with one or more embodiments described herein.

FIG. 6 illustrates an example, non-limiting method in accordance with one or more embodiments described herein.

FIG. 7 illustrates an example, non-limiting method in accordance with one or more embodiments described herein.

FIG. 8 illustrates an example graph in accordance with one or more embodiments described herein.

FIG. 9 illustrates an example graph in accordance with one or more embodiments described herein.

FIG. 10 illustrates an artificial intelligence based system including a workflow component in accordance with one or more embodiments described herein.

FIG. 11 illustrates an artificial intelligence based system including an avatar component in accordance with one or more embodiments described herein.

FIG. 12 illustrates an artificial intelligence based system including a virtual reality component in accordance with one or more embodiments described herein.

FIG. 13 illustrates an example, non-limiting method in accordance with one or more embodiments described herein.

FIG. 14 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Within the realm of aircraft LRU, information regarding LRUs is often hidden in thousands of documents, and can take countless man-hours to read and analyze. Oftentimes, much of the paperwork is not digital and the information available is primarily cost data that only discloses how much was paid for a component and on which date. The subject innovation can analyze thousands of reports and perform text analytics on unstructured historical and real-time data. Unstructured data can be transformed into structured data to gather meaningful information. Maintenance details can be uncovered such as parts consumed, how a component was tested, what were inspection results, causes of a service escalation or the like, a full part history report, etc. The voluminous LRU-related information can have significant potential for cost reductions, work scope reduction, work scope targeting, billing verification, etc., and the subject innovation provides for quickly analyzing such large corpus of data in a meaningful (e.g., structured) manner and gleaning highly useful insights that can facilitate decision making and action. For example, insights can be discovered regarding historical work to allow for optimization of repair. Real-time verification can allow for proactive cost control. It is contemplated that various systems incorporating novel aspects disclosed herein can apply to different fields other than aircraft operation and maintenance.

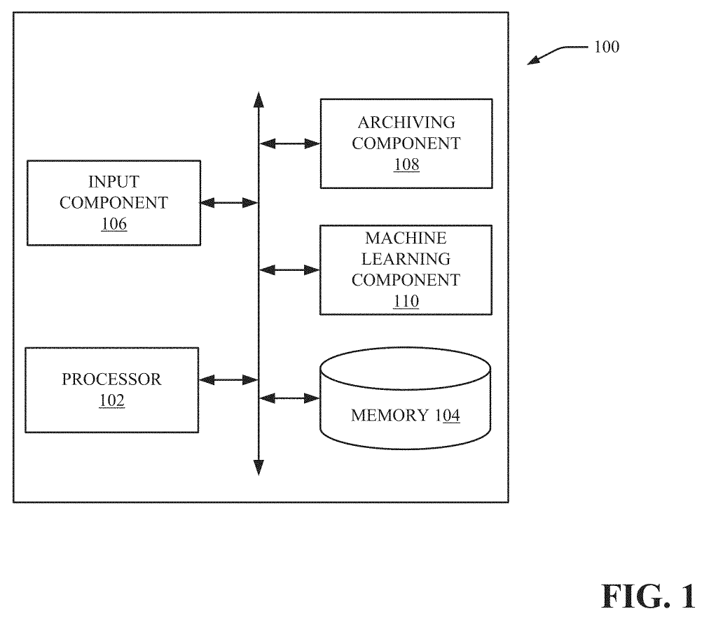

FIG. 1 illustrates an artificial intelligence based system 100 to improve aircraft operational and maintenance efficiency. The system 100 comprises processor 102 that executes computer executable components stored in memory 104. Computer executable components can include input component 106, archiving component 108, and machine learning component 110. Input component 106 can receive historical and real-time aircraft operation and maintenance data. Historical data can be obtained, for example, from past invoices, shop finding reports, certification reports, service bulletins, etc. The system 100 can analyze real-time data (e.g., in connection with just received same reports) as it arrives.

Archiving component 108 can store aircraft operation and maintenance data that input component 106 receives. Data can be archived for use by other components of system 100. Machine learning component 110 can learn unstructured received and archived aircraft operation and maintenance data, identify correlations across the data and generate suggestions in connection with improving operation of the aircraft. Artificial intelligence models can learn the received and archived aircraft operation and maintenance data, and augment respective AI models. An AI model, for example, can base replacement of an LRU at least in part on a utility based analysis to optimize operation and maintenance. A utility based analysis can consist of factoring predicted remaining life of the LRU, comparing the benefit of replacing the LRU at different point in time prior to end of life, etc. An AI model can schedule and automatically order a replacement LRU to maintain a certain amount of inventory relative to replacement requirements. An AI model can also rank quality of personnel that have operated or worked on the aircraft and provide suggestion regarding scheduling personnel based in part on the rankings and associated costs. Rankings can be based on quality, availability, affinity for certain tasks, etc. Respective AI models can interface with other AI models associated with different aircrafts and learn from each other. An AI model can reside across a distributed network of devices not limited to aircraft and can comprise, for example, both a neural network and a Bayesian network (e.g., in a recursive learning arrangement) to provide enhanced learning and prediction by the AI model.

Embodiments of devices described herein can employ artificial intelligence (AI) to facilitate automating one or more features described herein. The components can employ various AI-based schemes for carrying out various embodiments/examples disclosed herein. In order to provide for or aid in the numerous determinations (e.g., determine, ascertain, infer, calculate, predict, prognose, estimate, derive, forecast, detect) described herein, components described herein can examine the entirety or a subset of the data to which it is granted access and can provide for reasoning about or determine states of the system, environment, etc., from a set of observations as captured via events and/or data. Determinations can be employed to identify a specific context or action, and/or can generate a probability distribution over states, for example. The determinations can be probabilistic—that is, the computation of a probability distribution over states of interest based on a consideration of data and events. Determinations can also refer to techniques employed for composing higher-level events from a set of events and/or data.

Such determinations can result in the construction of new events or actions from a set of observed events and/or stored event data, whether or not the events are correlated in close temporal proximity, and whether the events and data come from one or several event and data sources. Components disclosed herein can employ various classification (explicitly trained (e.g., via training data) as well as implicitly trained (e.g., via observing behavior, preferences, historical information, receiving extrinsic information, etc.)) schemes and/or systems (e.g., support vector machines, neural networks, expert systems, Bayesian belief networks, fuzzy logic, data fusion engines, etc.) in connection with performing automatic and/or determined action in connection with the claimed subject matter. Thus, classification schemes and/or systems can be used to automatically learn and perform a number of functions, actions, and/or determination.

A classifier can map an input attribute vector, z=(z1, z2, z3, z4, zn), to a confidence that the input belongs to a class, as by f(z)=confidence(class). Such classification can employ a probabilistic and/or statistical-based analysis (e.g., factoring into the analysis utilities and costs) to determinate an action to be automatically performed. A support vector machine (SVM) is an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

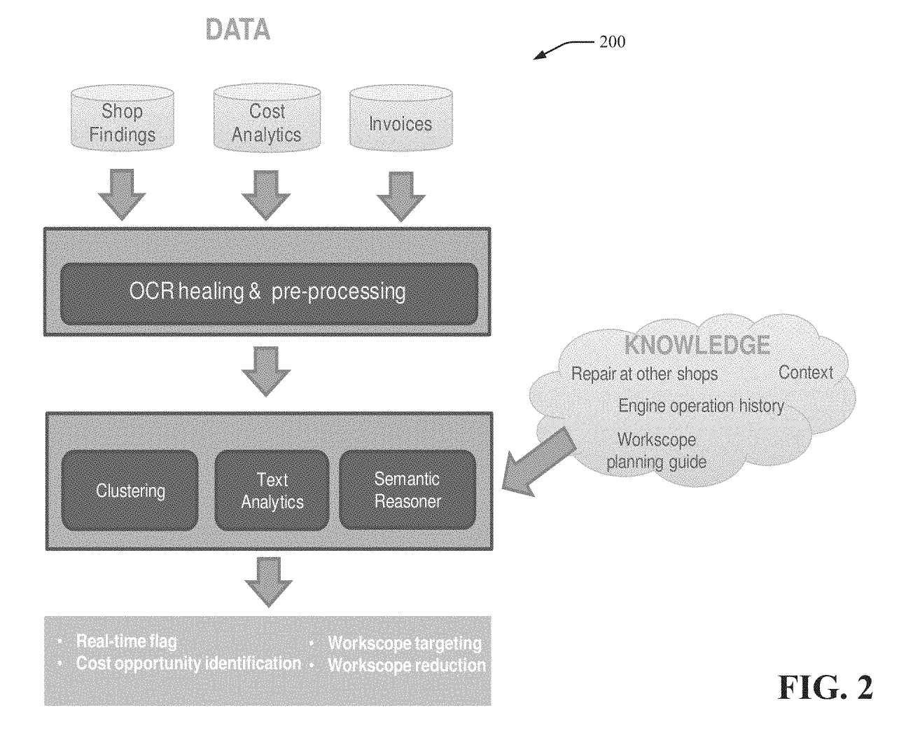

FIG. 2 illustrates an example, non-limiting method 200 to optimize aircraft LRU operation and maintenance. Data from multiple sources such as shop findings, cost analytics, and invoices are scanned and received by input component 106. Scanned text documents are in image file formats, which require employing optical character recognition (OCR) to convert to unstructured text data that is then parsed into a structured database, which can still contain errors. OCR healing and pre-processing repair data for analytics. OCR healing compares distance of words and phrases to reveal errors and correct the words or phrases. Real-time processing of purchasing documents can flag workscope creep, cost escapement, incorrect workscope, etc., to enable proactive cost control. Then different text analytics such as clustering, text analytics, semantic reasoner, etc., are conducted to optimize LRU maintenance. Clustering algorithms separate groups of LRU or parts with similar workscopes to make an anomalous cost signal apparent. Semantic reasoner can be applied for categorization of workscopes, bench test results, root cause, etc.

Accessibility of previously unused data improves understanding of workflow within and between shops. For example, this can explain why an LRU component moved to a different aircraft or whether it can be moved to another aircraft within a contract to optimize turn around time. This can also substantiate whether a component repair comply with contract guidelines, explain why repair escalated, disclose which service bulletins were applied, whether a service bulletin can be deferred at a certain point of an LRU life to reduce workscope, cost, etc.

Structuring and analyzing historical data leads to insights on cost reduction, workscope reduction, workscope targeting, billing verification, etc. For example, cost reduction can be accomplished by recognizing a different vendor could perform a repair for less. An example of workscope reduction can include realizing line items of a workscope are not actually necessary per a build standard. Workscope targeting can include using an engine's specific operating history to anticipate which work needs to be completed, and if an engine is performing in light duty it may continue performing with reduced workscope. Billing verification can be accomplished by checking that the workscope applied is billed at expected rate.

Real-time data analysis can recommend or check a workscope based on flight operations parameters, cumulative damage, cumulative cycles, etc. For example, real-time analysis can be used to proactively flag cost escapement allowing buyers to reject and amend proposals—this allows for proactive cost control rather than recognizing issues after all work is finalized.

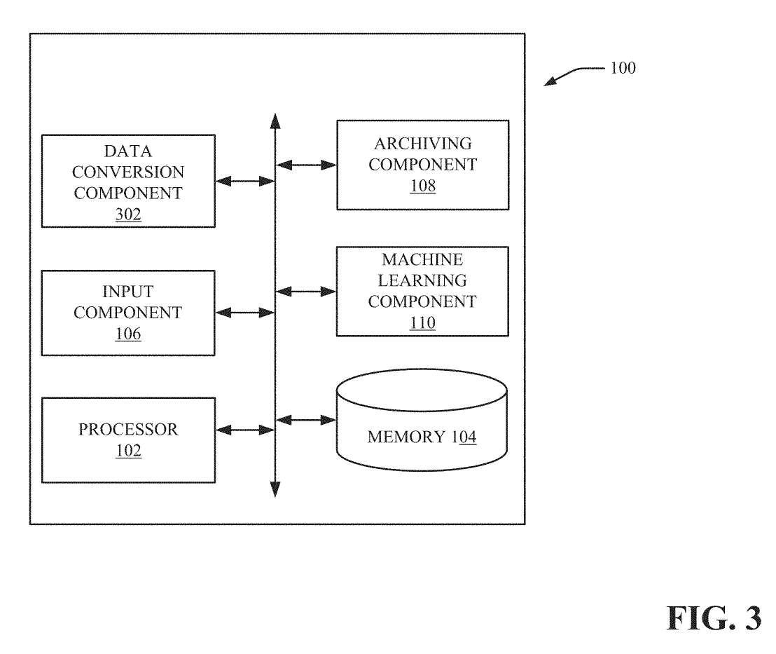

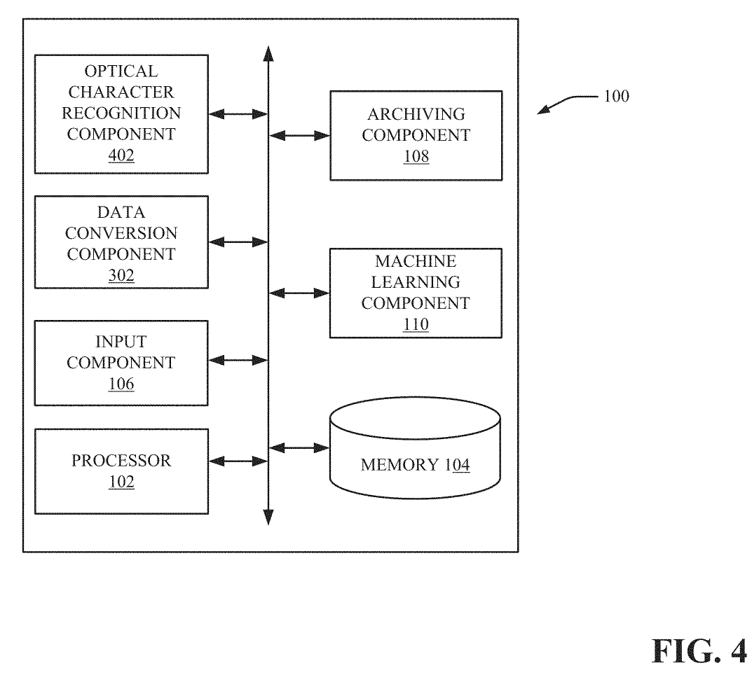

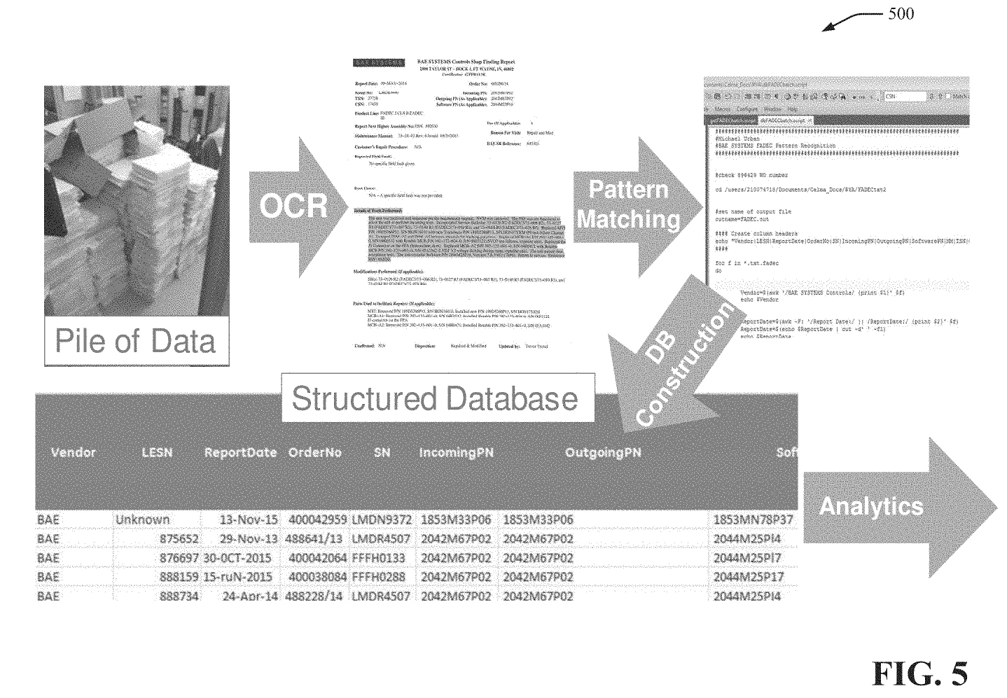

FIG. 3 illustrates an artificial intelligence based system 100 that includes a data conversion component 302 which can convert unstructured archived data to structured data that can be analyzed by the machine learning component through employment of optical character recognition (OCR) component 402, as illustrated in FIG. 4. FIG. 5 further illustrates an example method 500 depicting how text documents can be converted to structured data. A large set of data (e.g., paper files) can be scanned into image files, and data conversion component 302 can convert these documents which may have originated from multiple sources, vendors, formats, etc., into structured data by employing OCR component 402 and pattern matching algorithms using parsing codes, for example. OCR component 402 can convert text document image data into unstructured text data. Pattern matching algorithms using parsing codes can extract business critical data, which are stored in a database with standardized nomenclature (e.g., structured data). Storing unstructured data into a structured database facilitates analyses to be conducted on a wider breadth of data. Having an organized or structured database can substantially facilitate shop data analytics. Data that is stored in consistent and standard formats can greatly improve down-stream processing and capture workscope information.

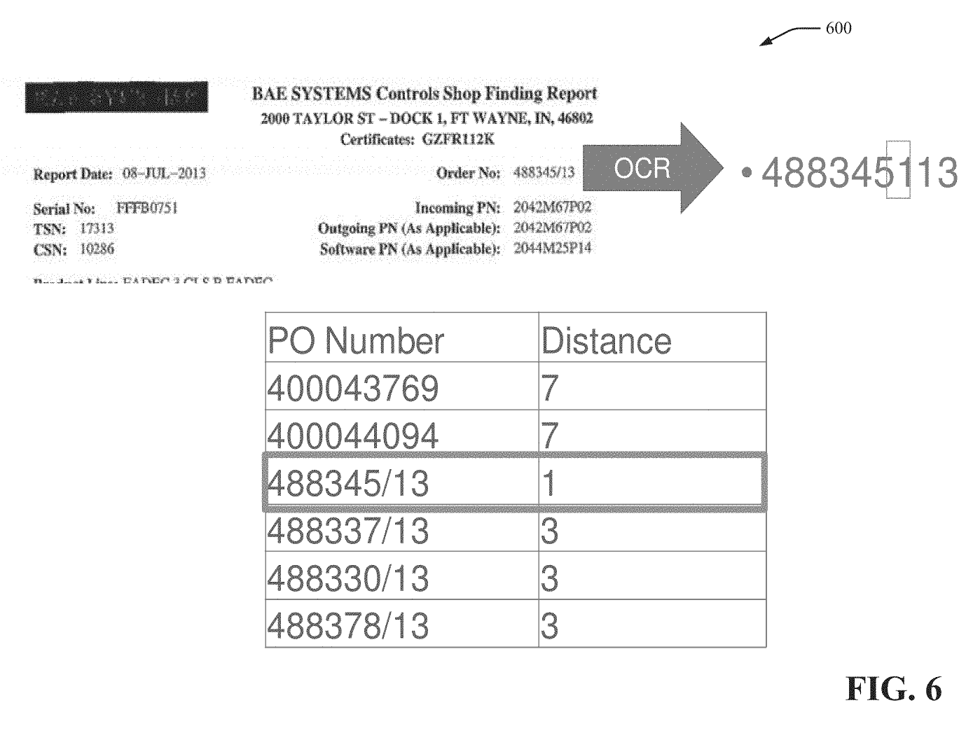

In the example from FIG. 5, there are errors in the structured database with “Jun” spelled as “ruN”, “OCT” spelled with a zero and some fields are missing, but analytics techniques such as OCR healing can cure these errors. OCR healing can utilize Levenshtein distance or string distance based comparison to determine a most likely intended word. Candidate words are scored by probability then chosen based upon the chosen probability threshold. Contextual rules are also applied to improve accuracy. For example, if a lowercase “L” is present in a part number where this hypothetical part only uses numeric, the letter “L” is most likely to be a “1.” In another example from FIG. 6, method 600 employs a string distance to find closest purchase order (PO) number by calculating distance between “488345113” and a list of known PO numbers to discover the “/” misread as “1.” This method can also be applied individually to clean existing data and reconcile mismatches in services databases. A major technical advantage to this method is that it enables the use of historical data that is archived in image only, non-text formats. Furthermore, the error mending algorithm enables quicker, more reliable analysis, as compared to conventional analytic techniques, without filtering out erroneous data. This method can also be applied to reconcile existing data discrepancies such as with part keywords that are not being translated correctly.

Text analytic and clustering algorithms are employed to determine causality between workscope, shop findings, applied service bulletins, costs, etc. For example, how groups of LRU behave in a specific region or with certain airlines, which groups that contain a specific part is more vulnerable, etc. A commercial advantage to this method is that it identifies parts and services that drive shop visit costs. These insights can be used to better negotiate with external vendors for better pricing. Text analytics “reads” a large set of documents, and reports on how each work order compares to another in terms of workscope, cost, age statistics (e.g., cycles since new, time since overhaul, etc.). Text analytics can also analyze context of vendor contracts. For example, fixed firm pricing typically leads to only 3 levels of cost signals.

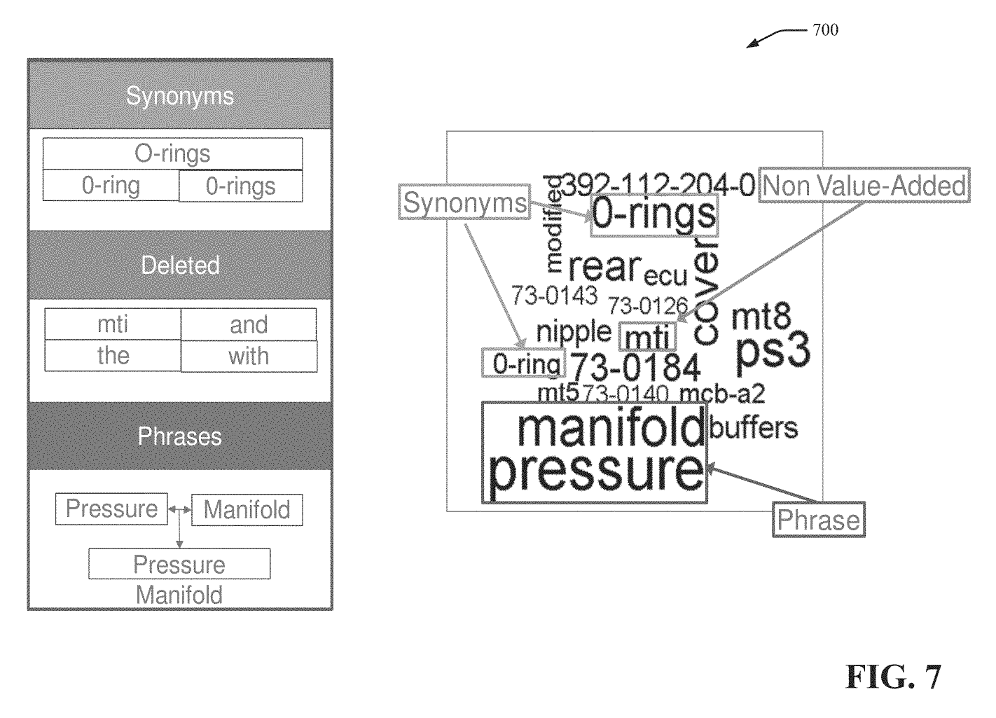

Deep learning can be applied to workscope forecasting based on airline, region, past workscopes, etc., to generate targeted workscopes. A dynamic and interactive wordcloud for building a dictionary can be used to efficiently extract important words exposing phrases and meaning behind some of those words. Users can actively identify which words or phrases are important or are synonyms to complement machine learning. FIG. 7 illustrates an example, non-limiting method 700 for building dynamic and interactive wordcloud that has drag and drop functionality. In FIG. 7, pressure manifold ended up being a word that is driving cost. Once important words are extracted, cost can be predicted based upon which words are present in each document. AI models can use machine learning to quickly recognize keywords and phrases. AI models can look for certain words based on past history, their quantified importance, and relevance to detect cost. In addition to detecting cost, AI models can also determine whether there is an error, if a component is being properly built, whether it is being built, etc. AI models can do this in real time so actions can be taken to correct problems immediately.

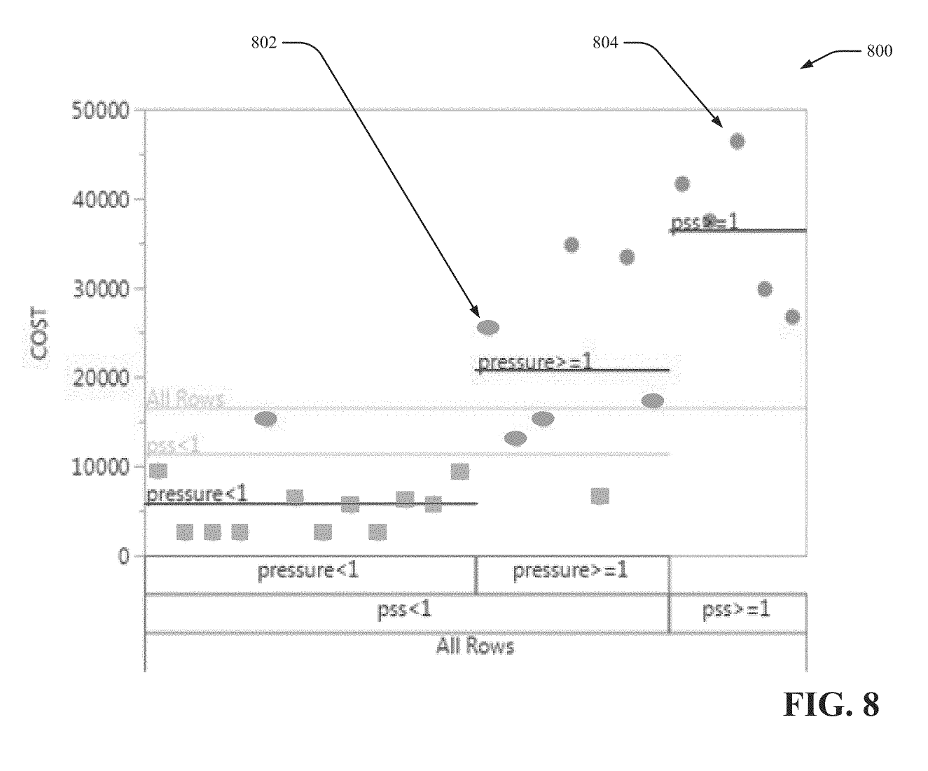

FIG. 8 illustrates an example graph 800 that correlates text with cost. Graph 800 depicts three levels of cost and how they correlate in order to correct cost problems. The pss was part of the pressure sub-system and manifold that was having issues driving cost. In example unit 802, the words MTI transducer, pressure manifold, and o-rings were replaced. Example unit 804 was received and inspected per the maintenance manual, but the pss was not functional to allow the unit to perform incoming tests. This method is especially valuable where there are fixed pricing contract, which greatly increase variance.

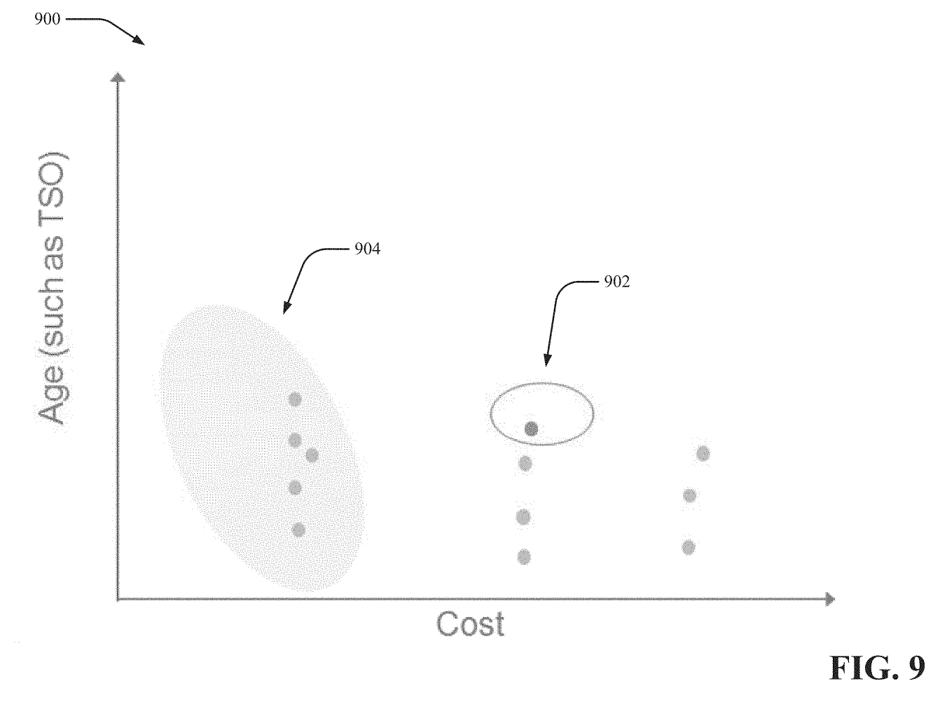

In another example, FIG. 9 illustrates graph 900 for workscope clustering to identify cost errors. Graph 900 has three different cost levels and one data point that is misplaced but is difficult to identify without applying workscope clustering. LRU 902 depicts an improperly applied workscope only visible by manually reading and recognizing the issues. Cluster 904 consists of 5 LRUs with the same workscope and cost threshold. LRU 902 has the same workscope, service bulletin, part number, etc., as those in cluster 904 but has a different cost. LRU 902 should belong with cluster 904 based on keywords that were selected from unstructured texts. It is likely a billing mistake that can be corrected using workscope clustering techniques.

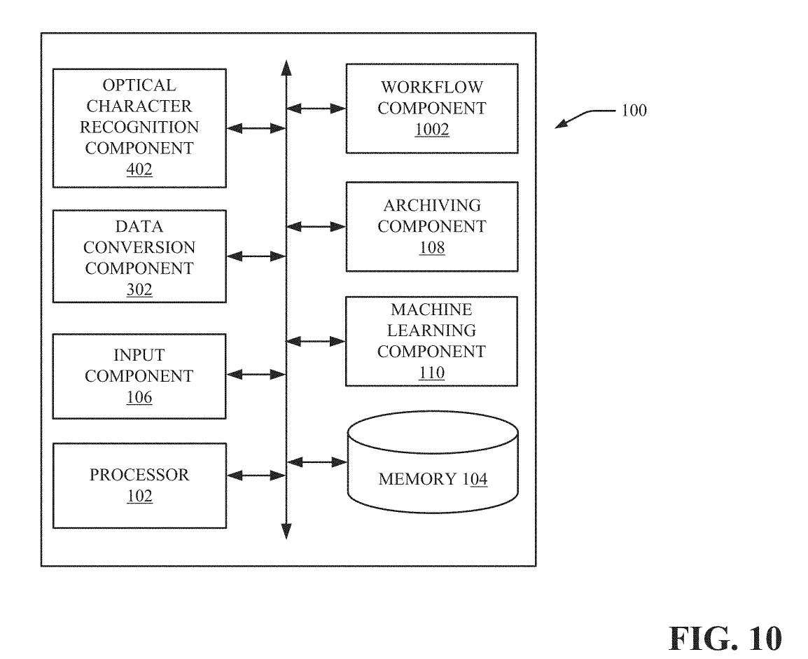

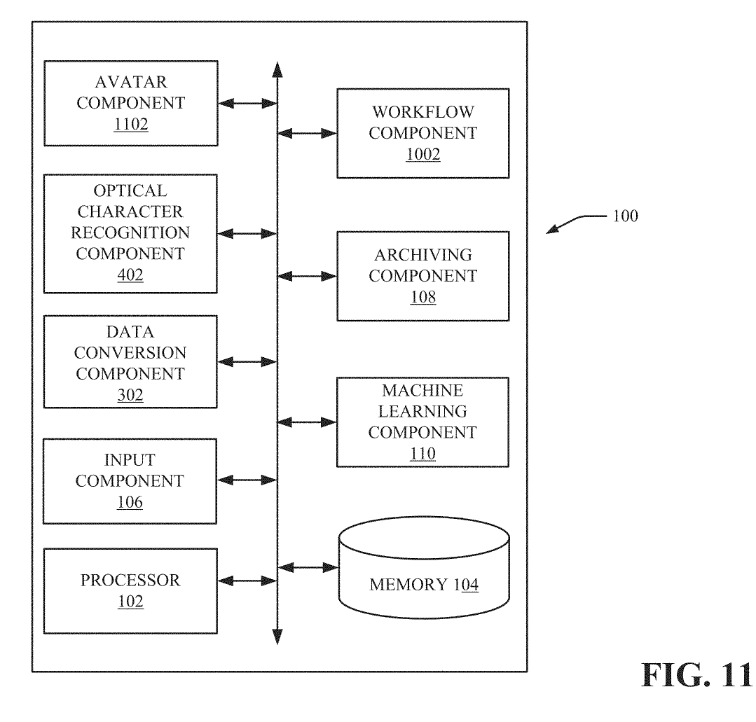

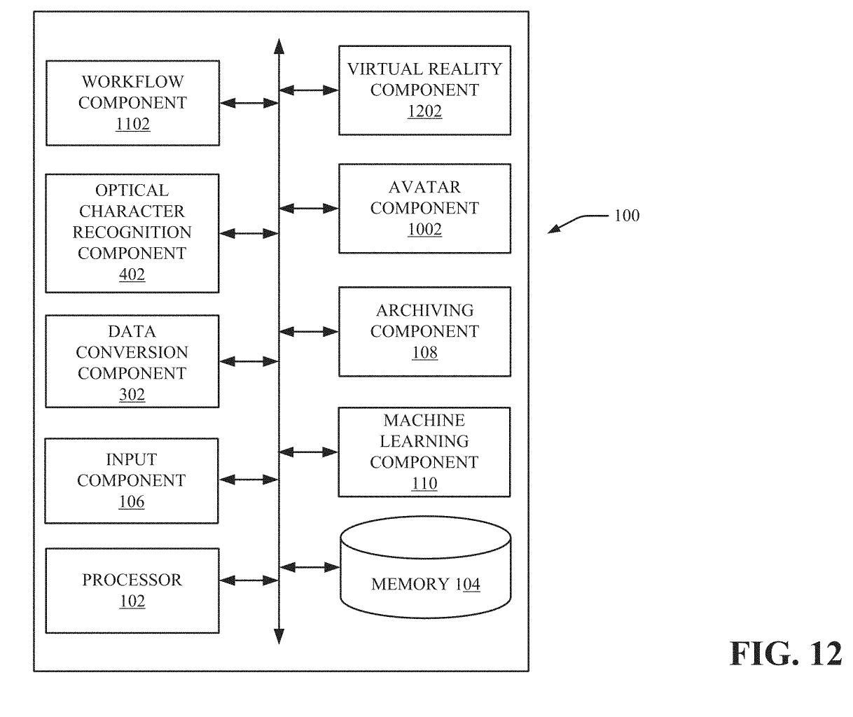

FIG. 10 illustrates an artificial intelligence based system including a workflow component 1002 that can adopt suggestions AI models generate to schedule operation and maintenance. For example, workflow component 1002 can schedule replacement LRU based on whether the AI model indicate a replacement is needed. Workflow component 1002 can schedule personnel based on who the AI model suggest is available and suitable for the position. Further, an avatar component 1102, as illustrated in FIG. 11, can generate an avatar that interfaces with a user and provide suggestions to the user based on outputs of the AI model. For example, the avatar can remind the user that a set of LRU needs to be replaced and ask whether the user want the avatar to order replacements. Additionally, a virtual reality component 1202, as illustrated in FIG. 12, can run simulations using suggestions from AI models and generate a virtual reality based presentation to a user. For example, a virtual reality simulation can demonstrate to maintenance group the proper way to replace an LRU.

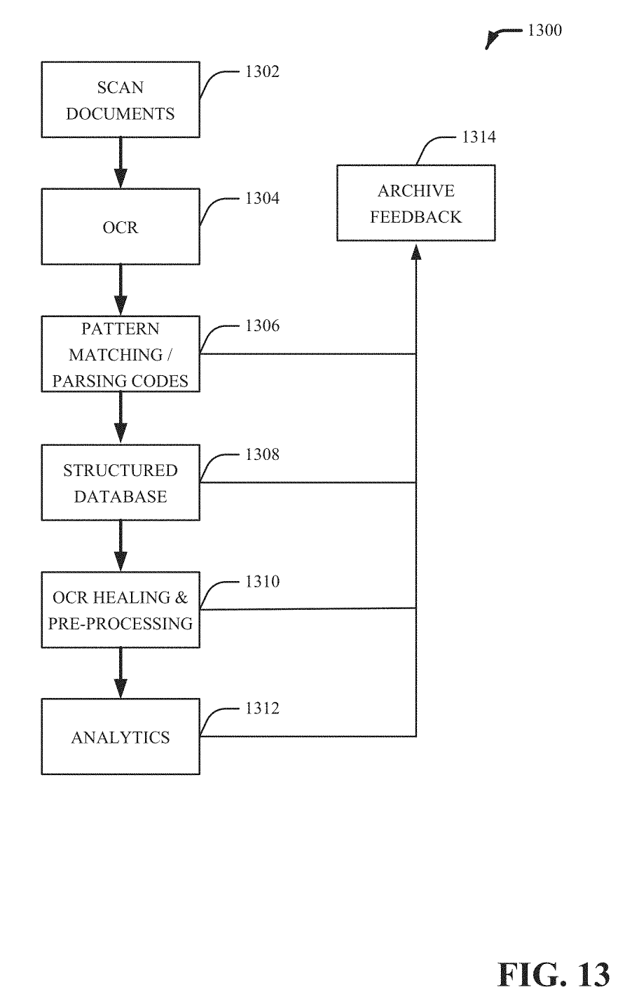

FIG. 13 illustrates an example, non-limiting method in accordance with one or more embodiments described herein to further demonstrate how every process is connected. At 1302, scan text documents into image file. At 1304, OCR is employed to convert text document images into unstructured text data. At 1306, a pattern matching algorithm is used with parsing codes to extract business critical data. At 1314, data feedback is archived for subsequent machine learning. At 1308, structured database(s) are constructed with standardized nomenclature, and archived for machine learning at 1314. At 1310, employ OCR healing and pre-processing to prepare data for analytics by correcting errors with techniques such as string distance and flagging workscope for proactive cost control. Archive data feedback for machine learning at 1314. At 1312, perform analytics such clustering, text analytics, semantic reasoner, etc., by employing wordcloud and text cost correlation. Archive data feedback for machine learning at 1314. Machine learning can use archived data to improve AI models.

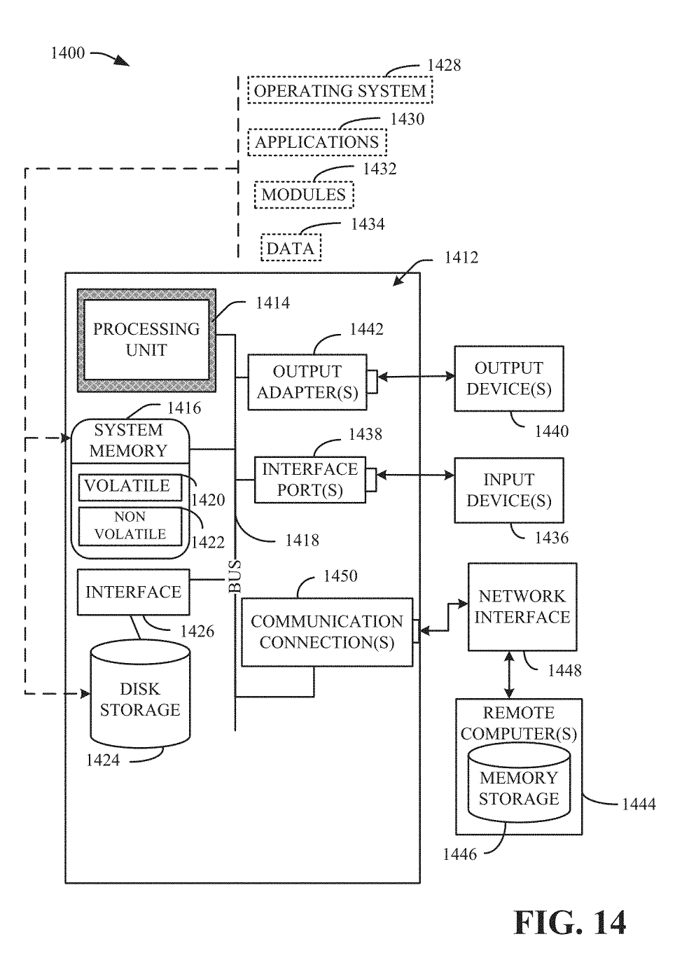

With reference to FIG. 14, a suitable operating environment 1400 for implementing various aspects of this disclosure can also include a computer 1412. The computer 1412 can also include a processing unit 1414, a system memory 1416, and a system bus 1418. The system bus 1418 couples system components including, but not limited to, the system memory 1416 to the processing unit 1414. The processing unit 1414 can be any of various available processors. Dual microprocessors and other multiprocessor architectures also can be employed as the processing unit 1414. The system bus 1418 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Firewire (IEEE 1394), and Small Computer Systems Interface (SCSI).

The system memory 1416 can also include volatile memory 1420 and nonvolatile memory 1422. The basic input/output system (BIOS), containing the basic routines to transfer information between elements within the computer 1412, such as during start-up, is stored in nonvolatile memory 1422. Computer 1412 can also include removable/non-removable, volatile/non-volatile computer storage media. FIG. 14 illustrates, for example, a disk storage 1424. Disk storage 1424 can also include, but is not limited to, devices like a magnetic disk drive, floppy disk drive, tape drive, Jaz drive, Zip drive, LS-100 drive, flash memory card, or memory stick. The disk storage 1424 also can include storage media separately or in combination with other storage media. To facilitate connection of the disk storage 1424 to the system bus 1418, a removable or non-removable interface is typically used, such as interface 1426. FIG. 14 also depicts software that acts as an intermediary between users and the basic computer resources described in the suitable operating environment 1400. Such software can also include, for example, an operating system 1428. Operating system 1428, which can be stored on disk storage 1424, acts to control and allocate resources of the computer 1412.

System applications 1430 take advantage of the management of resources by operating system 1428 through program modules 1432 and program data 1434, e.g., stored either in system memory 1416 or on disk storage 1424. It is to be appreciated that this disclosure can be implemented with various operating systems or combinations of operating systems. A user enters commands or information into the computer 1412 through input device(s) 1436. Input devices 1436 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1414 through the system bus 1418 via interface port(s) 1438. Interface port(s) 1438 include, for example, a serial port, a parallel port, a game port, and a universal serial bus (USB). Output device(s) 1440 use some of the same type of ports as input device(s) 1436. Thus, for example, a USB port can be used to provide input to computer 1412, and to output information from computer 1412 to an output device 1440. Output adapter 1442 is provided to illustrate that there are some output devices 1440 like monitors, speakers, and printers, among other output devices 1440, which require special adapters. The output adapters 1442 include, by way of illustration and not limitation, video and sound cards that provide a means of connection between the output device 1440 and the system bus 1418. It should be noted that other devices and/or systems of devices provide both input and output capabilities such as remote computer(s) 1444.

Computer 1412 can operate in a networked environment using logical connections to one or more remote computers, such as remote computer(s) 1444. The remote computer(s) 1444 can be a computer, a server, a router, a network PC, a workstation, a microprocessor based appliance, a peer device or other common network node and the like, and typically can also include many or all of the elements described relative to computer 1412. For purposes of brevity, only a memory storage device 1446 is illustrated with remote computer(s) 1444. Remote computer(s) 1444 is logically connected to computer 1412 through a network interface 1448 and then physically connected via communication connection 1450. Network interface 1448 encompasses wire and/or wireless communication networks such as local-area networks (LAN), wide-area networks (WAN), cellular networks, etc. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL). Communication connection(s) 1450 refers to the hardware/software employed to connect the network interface 1448 to the system bus 1418. While communication connection 1450 is shown for illustrative clarity inside computer 1412, it can also be external to computer 1412. The hardware/software for connection to the network interface 1448 can also include, for exemplary purposes only, internal and external technologies such as, modems including regular telephone grade modems, cable modems and DSL modems, ISDN adapters, and Ethernet cards.

The present invention may be a system, a method, an apparatus and/or a computer program product at any possible technical detail level of integration. The computer program product can include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer and/or computers, those skilled in the art will recognize that this disclosure also can or can be implemented in combination with other program modules. Generally, program modules include routines, programs, components, data structures, etc. that perform particular tasks and/or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. An artificial intelligence based system to improve aircraft operational and maintenance efficiency, comprising:
a processor that executes the following computer executable components stored in a memory, comprising:
an input component that receives historical and real-time aircraft operation and maintenance data from a set of sources;
an archiving component that stores at least a subset of the aircraft operation and maintenance data; and
a machine learning component that learns the received and archived aircraft operation and maintenance data, and augments an artificial intelligence (AI) model, wherein the model identifies correlations across a corpus of data, and generates suggestions in connection with improving operation of the aircraft.

2. The system of claim 1, wherein the machine learning component performs recursive learning across unstructured subsets of the received and archived aircraft operation and maintenance data.

3. The system of claim 1, wherein the AI model schedules replacement of a line replaceable unit (LRU) of the aircraft.

4. The system of claim 3, wherein the AI models bases the replacement of the LRU at least in part on a utility based analysis that factors predicted remaining life of the LRU and compares benefit of replacement at different point in time prior to end of life of the LRU.

5. The system of claim 1, further comprising a data conversion component that converts unstructured archived data to structured data that can be analyzed by the machine learning component.

6. The system of claim 5, further comprising an optical character recognition (OCR) component that converts text document image to unstructured data.

7. The system of claim 1, further comprising a workflow component that schedules aircraft operation and maintenance based on outputs generated by the AI model.

8. The system of claim 1, further comprising an avatar component that generates an avatar that interfaces with a user and provides suggestions to the user based on outputs of the AI model.

9. The system of claim 1, wherein the AI model comprises a neural network and a Bayesian network.

10. The system of claim 1, wherein the AI model interfaces with other AI models associated with different aircrafts, and learns from the other AI models.

11. The system of claim 1, wherein the AI model ranks quality of personnel that have operated or worked on the aircraft.

12. The system of claim 11, wherein the AI model provides suggestions regarding scheduling of a subset of the personnel based in part on the rankings and costs associated therewith.

13. The system of claim 1, wherein the AI model resides across a distributed network of devices.

14. The system of claim 1, further comprising a virtual reality component that runs simulations using suggestions from the AI model and generates a virtual reality based presentation to a user of one or more of the simulations.

15. The system, of claim 3, wherein the AI model automatically orders the replacement LRU.

16. A computer-implemented method for improving aircraft operational and maintenance efficiency, comprising:
employing a processor to execute computer executable components stored in a memory to perform the following acts:
using an input component to receive historical real-time aircraft operation and maintenance data from a set of sources; and
using an archiving component to store at least a subset of the aircraft operation and maintenance data;
using a machine learning component to learn the received and archived aircraft operation and maintenance data, and augment an artificial intelligence (AI) model, wherein the model identifies correlations across a corpus of data, and generates suggestions in connection with improving operation of the aircraft.

17. The method of claim 16, further comprising using the data conversion component to convert unstructured archived data to structured data that can be analyzed by the machine learning component.

18. The method of claim 17, further comprising using an optical character recognition (OCR) component to convert text document image to unstructured data.

19. A computer program product for improving aircraft operational and maintenance efficiency, the computer program product comprising a computer readable storage medium having program instructions embodied therewith, the program instructions executable by a processor to cause the processor to:
use an input component to receive historical and real-time aircraft operation and maintenance data from a set of sources;
use an archiving component to store at least a subset of the aircraft operation and maintenance data; and
use a machine learning component to learn the received and archived aircraft operation and maintenance data, and augment an artificial intelligence (AI) model, wherein the model identifies correlations across a corpus of data, and generates suggestions in connection with improving operation of the aircraft.

20. The computer program product of claim 19, wherein the program instructions are further executable by the processor to cause the processor to: use the data conversion component to convert unstructured archived data to structured data that can be analyzed by the machine learning component.
